(19) United States
(12) Patent Application Publication
(10) Pub. No.: US 2022/0050583 A1
(43) Pub. Date: Feb. 17, 2022

(54) IMAGE PROCESSING APPARATUS, IMAGE PROCESSING METHOD, AND PROGRAM

(71) Applicant: SONY GROUP CORPORATION, Tokyo (JP)

(72) Inventor: Shogo TAKANASHI, Tokyo (JP)

(73) Assignee: SONY GROUP CORPORATION, Tokyo (JP)

(21) Appl. No.: 17/312,205

(22) PCT Filed: Oct. 17, 2019
(86) PCT No.: PCT/JP2019/040919

§ 371 Date: Jun. 9, 2021

(30) Foreign Application Priority Data
Dec. 17, 2018 (JP) 2018-235747

(51) Int. Cl. G06F 3/0484; G06T 5/00; G06T 7/90; G06K 9/46

(52) U.S. Cl. CPC G06F 3/04845; G06K 9/4652; G06T 7/90; G06T 5/009

(57) ABSTRACT

Visibility of a writing content image of writing contents written on a writing surface can be enhanced. There is provided an image processing apparatus including processing circuitry. The processing circuitry is configured to modify one or more characteristics of a writing content image of writing contents written on a writing surface. The modification of the one or more characteristics of the writing content image is based on information related to the writing surface.

### CROSS REFERENCE TO RELATED APPLICATIONS

This application claims the benefit of Japanese Priority Patent Application JP 2018-235747 filed on Dec. 17, 2018, the entire contents of which are incorporated herein by reference.

### TECHNICAL FIELD

The present disclosure relates to an image processing apparatus, an image processing method, and a program.

### BACKGROUND ART

In recent years, there has been developed a technology for extracting writing on a blackboard, whiteboard, or the like and outputting the information indicating the extracted writing. For example, PTL 1 discloses a technology for shooting an image of a blackboard, whiteboard, or the like, extracting an image corresponding to the writing from the shot image, and outputting the extracted image.

### CITATION LIST

### Patent Literature

PTL 1: JP 2016-30369A

### SUMMARY

### Technical Problem

However, an extracted image is output as monochrome image data according to the technology described in PTL 1, and thus poor visibility of the image is assumed. Further, even in a case where the extracted image is output as a color image, it can seem different between in a case where the writing is directly viewed in a physical space and in a case where it is viewed on a display, and thus poor visibility of the image is assumed.

Further, writing is typically made to be adapted to an object to be written. Thus, in a case where an image of writing is extracted and is combined with an image of a background different from the object to be written to be output as an output image, poor visibility of the image of the writing in the output image is assumed.

### Solution to Problem

According to the present disclosure, there is provided an image processing apparatus including processing circuitry. The processing circuitry is configured to modify one or more characteristics of a writing content image of writing contents written on a writing surface. The modification of the one or more characteristics of the writing content image is based on information related to the writing surface.

Further, according to the present disclosure, there is provided an image processing method. The image processing method includes modifying, by processing circuitry of an image processing apparatus, one or more characteristics of a writing content image of writing contents written on a writing surface. The modification of the one or more characteristics of the writing content image is based on information related to the writing surface.

Further, according to the present disclosure, there is provided a non-transitory computer-readable storage medium storing instructions which when executed by a computer cause the computer to perform a method. The method includes modifying one or more characteristics of a writing content image of writing contents written on a writing surface. The modification of the one or more characteristics of the writing content image is based on information related to the writing surface.

### BRIEF DESCRIPTION OF DRAWINGS

FIG. 1 is a diagram for explaining an outline of an image processing apparatus 100 and an input apparatus 200 according to an embodiment of the present disclosure.

FIG. 2 is a diagram for explaining an exemplary functional configuration of a system 1 according to the present embodiment.

FIG. 3 is a diagram for explaining an exemplary image acquired by an acquisition unit 11 according to the present embodiment.

FIG. 4 is a diagram for explaining an exemplary extraction processing by an extraction unit 14 according to the present embodiment.

FIG. 5 is a diagram for explaining an exemplary object-to-be-written area extraction processing by the extraction unit 14 according to the present embodiment.

FIG. 6 is a diagram for explaining an exemplary result of the object-to-be-written area extraction processing by the extraction unit 14 according to the present embodiment.

FIG. 7 is a diagram for explaining an exemplary correction method by a correction unit 15 according to the present embodiment.

FIG. 8 is a diagram for explaining an exemplary correction method by the correction unit 15 according to the present embodiment.

FIG. 9 is a diagram for explaining an exemplary correction method by the correction unit 15 according to the present embodiment.

FIG. 10 is a diagram for explaining exemplary correction in a quadratic curve in hue at a hue angle of 50 degrees to 70 degrees by the correction unit 15 according to the present embodiment.

FIG. 11 is a diagram for explaining a specific example of performing the correction processing using a filter by the correction unit 15 according to the present embodiment.

FIG. 12 is a diagram for explaining an exemplary processing of correcting a contour of a writing content image 22 by the correction unit 15 according to the present embodiment.

FIG. 13 is a diagram for explaining exemplary output by an output apparatus 300 according to the present embodiment.

FIG. 14 is a diagram for explaining an exemplary flow of operations of the system 1 according to the present embodiment.

FIG. 15A is a diagram for explaining an exemplary correction processing based on behavior detection information indicating whether or not a writer is writing on an object 2 to be written by the correction unit 15 according to the present embodiment.

FIG. 15B is a diagram for explaining an exemplary correction processing based on behavior detection information indicating whether or not a writer is writing on the object 2 to be written by the correction unit 15 according to the present embodiment.

FIG. 16 is a diagram for explaining a writing content image correction processing based on a position relationship between a writer 3 and the object 2 to be written by the correction unit 15 according to the present embodiment.

FIG. 17 is a block diagram illustrating an exemplary hardware configuration of an information processing apparatus including the system 1 according to an embodiment of the present disclosure.

### DESCRIPTION OF EMBODIMENTS

An embodiment of the present disclosure will be described below in detail with reference to the accompanying drawings. Additionally, the components having substantially the same functional configurations are denoted with the same reference numerals in the present specification and the drawings, and a repeated description thereof will be omitted.

Additionally, the description will be made in the following order.

1. Embodiment

1-1. Background

1-2. Exemplary entire configuration

1-3. Exemplary functional configuration

2. Exemplary operations

3. Applications

3-1. Application 1

3-2. Application 2

4. Exemplary hardware configuration

5. Conclusion

### 1. EMBODIMENT

<<1-1. Background>>

The background of an embodiment of the present disclosure will be first described.

In recent years, there has been developed a technology for extracting writing (denoted as writing contents 4 below) on an object 2 to be written from an image shot of a blackboard, whiteboard, or the like (denoted as object 2 to be written or a writing surface below), and outputting the extracted writing contents 4 as an image. An image of the writing contents 4 (denoted as writing content image 22 below) is output on a display or the like in the scene of lecture, conference, or the like so that remote participants can easily confirm the writing contents, for example.

Incidentally, in a case where the shot writing contents 4 are output as the writing content image 22, poor visibility of the writing content image 22 is assumed. This may be because writing contents can seem different between in a case where they are directly viewed in a physical space, in a case where the writing content image 22 is viewed on a display, and the like, for example.

Further, a frequently-used color for writing can be typically different for each kind of the object 2 to be written. Thus, poor visibility of the writing content image 22 included in an output image is assumed depending on a combination of a color used for writing and a background color of the output image.

The technical spirit according to an embodiment of the present disclosure is assumed in terms of the above points, and enables a form of a writing content image to be corrected for better visibility of the writing content image. An exemplary configuration and exemplary operations according to an embodiment of the present disclosure will be sequentially described below in detail.

<<1-2. Exemplary Entire Configuration>>

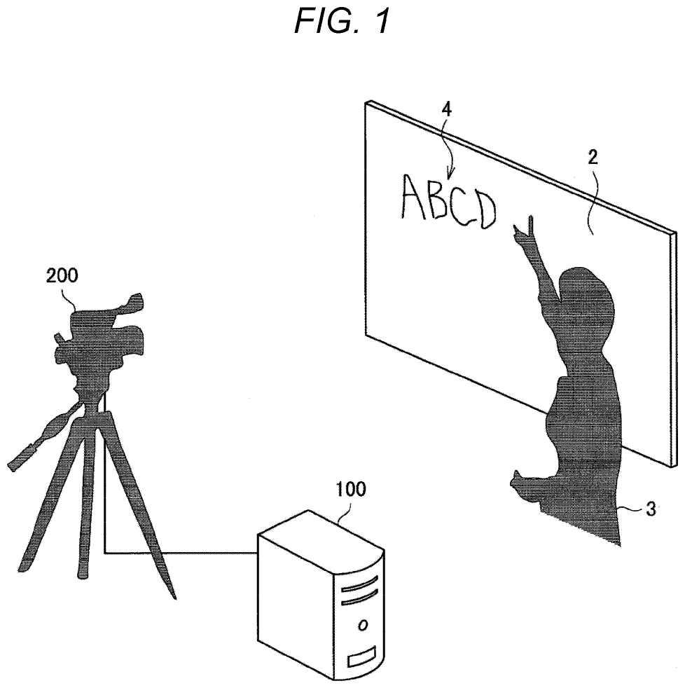

An outline of an image processing apparatus 100 and an input apparatus 200 according to an embodiment of the present disclosure will be subsequently described with reference to FIG. 1.

FIG. 1 is a diagram for explaining an outline of the image processing apparatus 100 and the input apparatus 200 according to an embodiment of the present disclosure. FIG. 1 illustrates the image processing apparatus 100 and the input apparatus 200 connected to the image processing apparatus 100.

The object 2 to be written is an object on which visual information (writing contents 4) such as dots, lines, characters, sentences, mathematical expressions, symbols, pictures, graphics, or images is written. The object 2 to be written (or writing surface) is a blackboard, a whiteboard, electronic paper, a touch panel, or the like.

A writer 3 operates the object 2 to be written. For example, the writer 3 writes the writing contents 4 on the object 2 to be written.

The writing contents 4 are visual information written on the object 2 to be written. As described above, the writing contents 4 are written on the object 2 to be written with a chalk, a maker, a stylus pen, a finger, or the like. Additionally, the writing contents 4 may be in various colors. For example, in a case where the object 2 to be written is a blackboard, the writing contents 4 are in white, red, yellow, or the like.

The input apparatus 200 is an apparatus for inputting information regarding a physical space in which the input apparatus 200 is installed. The input apparatus 200 includes a shooting apparatus and a speech input apparatus, for example. The shooting apparatus includes a lens system configured of a shooting lens, a diaphragm, a zoom lens, a focus lens, and the like, a drive system for causing the lens system to perform a focus operation or a zoom operation, a solid-state imaging device array for photoelectrically converting a shooting light obtained by the lens system thereby to generate a shooting signal, and the like. The speech input apparatus includes signal processing circuits such as a microphone for collecting surrounding sounds, a microphone amplifier circuit for amplifying a speech signal obtained by the microphone, an A/D converter, and a noise canceller. The input apparatus 200 outputs image data as a digital signal, and speech data during shooting.

The input apparatus 200 can shoot an image of an object in a physical space as an object to shoot. Additionally, the input apparatus 200 may shoot an image of the object 2 to be written which the writing contents 4 are written on in a physical space, and may associate a shooting time with the shot image (denoted as shot image 20 below) and output them to the image processing apparatus 100. The shot image 20 may include areas other than the object 2 to be written and the writing contents 4. In this case, the input apparatus 200 outputs the shot image shooting other than the object 2 to be written and the writing contents 4 therein to the image processing apparatus 100.

Further, the object 2 to be written may have the functions of the input apparatus 200. For example, the input apparatus 200 and the object 2 to be written are realized as electronic blackboard. The input apparatus 200 as electronic blackboard may acquire an image corresponding to the shot image 20 by scanning a state of the object 2 to be written. In this case, the input apparatus 200 acquires an image of the object 2 to be written which the writing contents 4 are written on, and provides it to the image processing apparatus 100. The image may be handled similarly to the shot image 20 after being provided to the image processing apparatus 100. Additionally, the images acquired by the input apparatus 200 and the object 2 to be written, which are realized as electronic blackboard, may include only the object 2 to be written and the writing contents 4.

The image processing apparatus 100 is an apparatus for extracting the writing content image 22 from the shot image 20 input by the input apparatus 200 and correcting (or modifying) a form (or characteristic) of the extracted writing content image 22. The image processing apparatus 100 outputs the image including the corrected writing content image 22 (denoted as output image 25 below) to an output apparatus 300 (not illustrated in FIG. 1) described below.

Here, the form (or characteristic) of the writing content image 22 means color, width, contour, or the like of the writing content image 22, for example. Detailed correction of color, width, and contour of the writing content image 22 by the image processing apparatus 100 will be described below. Additionally, the image processing apparatus 100 may be connected to the input apparatus 200 in a wired or wireless manner.

<<1-3. Exemplary Functional Configuration>>

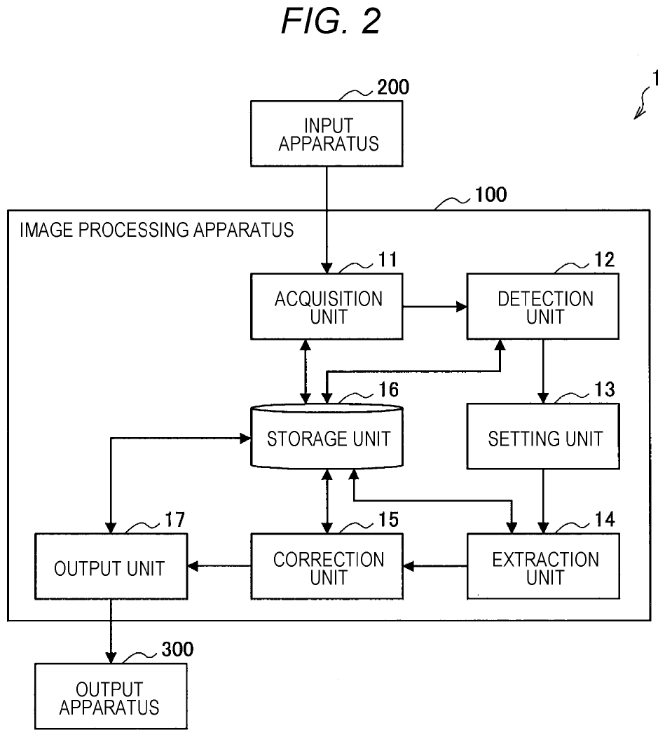

An exemplary functional configuration of a system 1 according to the present embodiment will be described below. FIG. 2 is a diagram for explaining an exemplary functional configuration of the system 1 according to the present embodiment. As illustrated in FIG. 2, the system 1 includes the image processing apparatus 100, the input apparatus 200, and the output apparatus 300.

<<1-3-1. Input Apparatus 200>>

The input apparatus 200 has the shot image 20 input, and outputs the shot image 20 to the image processing apparatus 100.

<<1-3-2. Image Processing Apparatus 100>>

The image processing apparatus 100 is an apparatus for controlling the entire operations of the system 1. The image processing apparatus 100 is realized by any apparatus such as personal computer (PC), Smartphone, or tablet terminal.

The image processing apparatus 100 extracts the writing content image 22 from the shot image input by the input apparatus 200, and the image processing apparatus 100 corrects the form of the extracted writing content image 22, and generates the output image 25 including the corrected writing content image 22 and having the background in a predetermined color.

As illustrated in FIG. 2, the image processing apparatus 100 includes an acquisition unit 11, a detection unit 12, a setting unit 13, an extraction unit 14, a correction unit 15, a storage unit 16, and an output unit 17, which can be implemented by processing circuitry for example.

(1-3-2-1. Acquisition Unit 11)

The acquisition unit 11 has a function of acquiring the shot image 20 from the input apparatus 200. The shot image 20 may include areas other than the object 2 to be written which the writing contents 4 are written on.

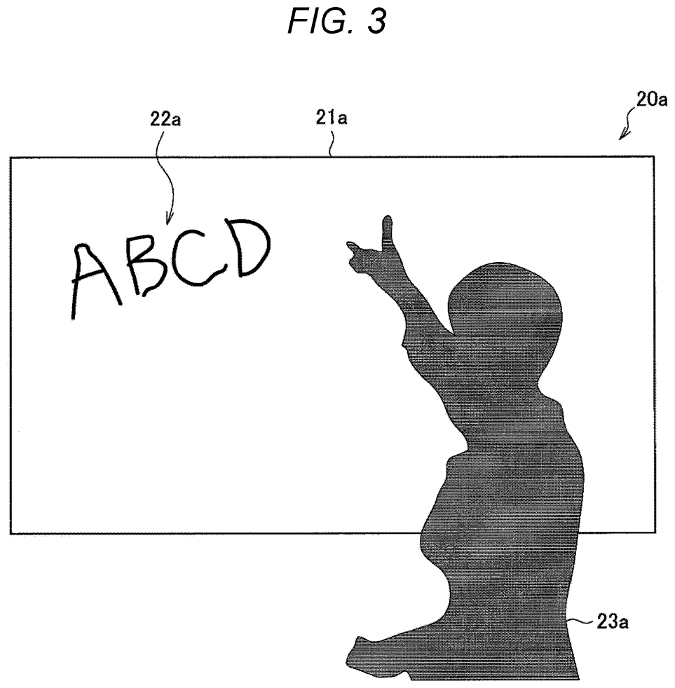

The shot image 20 acquired by the acquisition unit 11 according to the present embodiment will be described herein by way of example with reference to FIG. 3. FIG. 3 is a diagram for explaining the shot image 20 acquired by the acquisition unit 11 according to the present embodiment by way of example. FIG. 3 illustrates a shot image 20a. The shot image 20a includes an object-to-be-written image 21a, a writing content image 22a, and a writer image 23a.

In the example of FIG. 3, the shot image 20a includes the writer image 23a and other areas in addition to the object-to-be-written image 21a and the writing content image 22a.

Here, as described above, an object-to-be-written image 21 is an area (image) in which the object 2 to be written is shot in the shot image 20. Further, the writing content image 22 is an area (image) in which the writing contents 4 are shot in the shot image 20.

Additionally, the shot image 20 can have a predetermined rate or more of the writing content image 22. The shot image 20 may use an image subjected to the white balance correction. In a case where the input apparatus 200 is an electronic blackboard, an image including only the object-to-be-written image 21 and the writing content image 22 can be easily acquired by the acquisition unit 11. On the other hand, even in a case where the input apparatus 200 is an electronic blackboard, the acquisition unit 11 may acquire the shot image 20 in which an image of the electronic blackboard is shot by the shooting apparatus from the input apparatus 200.

(1-3-2-2. Detection Unit 12)

The detection unit 12 detects information related to the object 2 to be written, for example on the basis of the object-to-be-written image 21 included in the shot image 20. The information related to the object 2 to be written can be related to influence of light reflection and/or influence of surface residue/dirt (e.g., chalk or ink residue). The information related to the object to be written can include information indicating the object 2 to be written on the basis of the object-to-be-written image 21 included in the shot image 20. Additionally, the information indicating the object 2 to be written may be the kind of the object 2 to be written, for example. Specifically, for example, the detection unit 12 may perform an image recognition processing on the basis of the shot image 20 and labeled data thereby to detect the kind of the object 2 to be written. Here, the kind of the object 2 to be written is a blackboard, a whiteboard, an electronic blackboard, or the like, for example. The labeled data is data in which an image shooting a blackboard, a whiteboard, an electronic blackboard, or the like therein is labelled, for example.

Additionally, the detection unit 12 may detect the information indicating the object 2 to be written with reference to the storage unit 16 described below.

Further, the detection unit 12 may detect a state of the writer 3. The state of the writer 3 may be a motion state of the writer 3, for example. The state of the writer 3 is used for the correction processing by the correction unit 15 described below.

(1-3-2-3. Setting Unit 13)

The setting unit 13 sets the color of the background of the output image 25. Here, the background of the output image 25 is the background of an image output by the output apparatus 300. The color of the background may be white, black, or the like, for example. The color of the background may be set in a different color per output image 25, or may be set in a fixed color. The color of the background set by the setting unit 13 is used for the correction processing by the correction unit 15 described below.

(1-3-2-4. Extraction Unit 14)

The extraction unit 14 extracts the writing content image 22 from the shot image 20. Specifically, the extraction unit 14 extracts the writing content image 22 independent of the object-to-be-written image 21 or the like. That is, the extraction unit 14 generates image data including only the writing content image 22. The method for extracting the writing content image 22 may be a binarization processing or the like, for example.

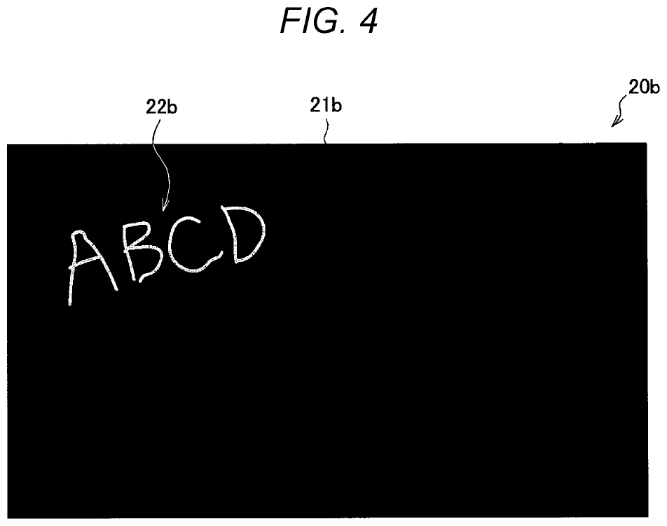

FIG. 4 is a diagram for explaining an exemplary extraction processing by the extraction unit 14 according to the present embodiment. FIG. 4 illustrates a shot image 20b subjected to the extraction processing. The shot image 20b subjected to the extraction processing includes a writing content image 22b. The object-to-be-written image 21 is removed to be a blank space 21b. The writing content image 22b can be extracted as illustrated in FIG. 4. Here, the writing content image 22b is in white in the example of FIG. 4.

However, it may be difficult to extract only the writing content image 22 in the binarization processing or the like by the extraction unit 14. For example, as illustrated in FIG. 3, the shot image 20 may include the writer image 23 or other area in addition to the object-to-be-written image 21 and the writing content image 22, and another area except the writing content image 22 may be extracted when the binarization processing is performed, for example. The writer image 23 or other area needs to be removed from the shot image 20 in order to extract only the writing content image 22.

The extraction unit 14 performs the processing of extracting an object-to-be-written area in order to remove the other area. Further, the extraction unit 14 performs a processing of separating the writer image 23 in order to remove the writer image 23. The processing of extracting an object-to-be-written area and the processing of separating the writer image 23 will be described below in detail.

(1-3-2-4-1. Processing of Extracting Object-to-be-Written Area)

The processing of extracting an object-to-be-written area will be first described. Specifically, the processing of extracting an object-to-be-written area is a processing of extracting, as an object-to-be-written area, an area which is specified by designating a plurality of points, or four points, for example, in the shot image 20. The object-to-be-written area herein is an image with the other area removed from the shot image 20.

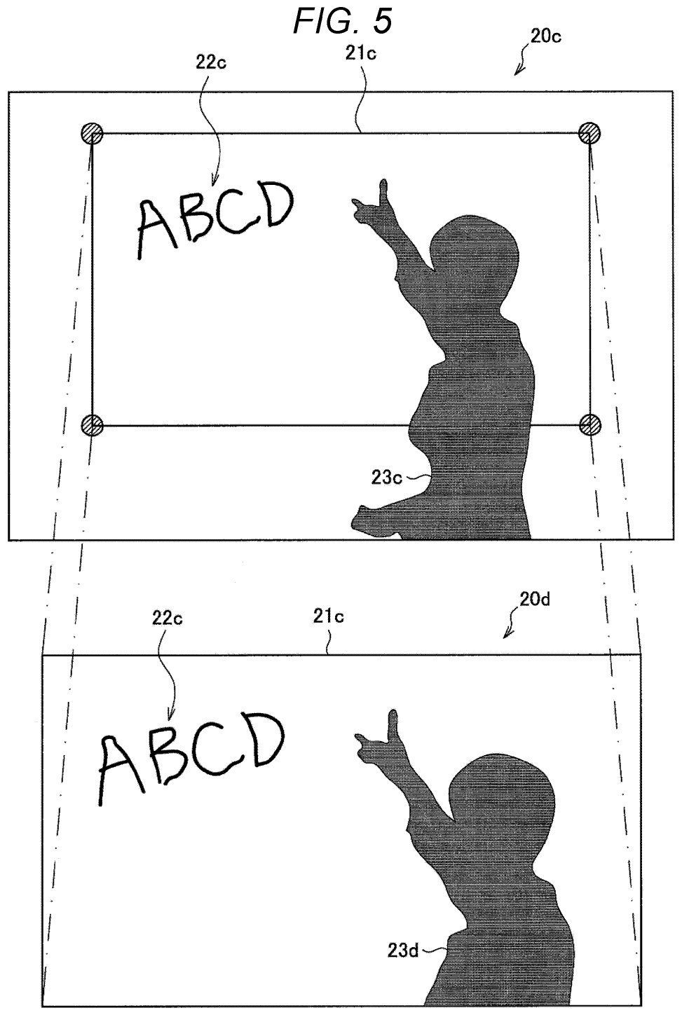

The description will be made below with reference to FIG. 5. FIG. 5 is a diagram for explaining the processing of extracting an object-to-be-written area by the extraction unit 14 according to the present embodiment by way of example. FIG. 5 illustrates a shot image 20c, and a shot image 20d with an object-to-be-written area extracted.

The shot image 20c herein includes a writer image 23c or other area in addition to an object-to-be-written image 21c and a writing content image 22c. The extraction unit 14 generates the shot image 20d with the object-to-be-written area extracted depending on a plurality of points designated to surround the area of the object 2 to be written on the basis of the object-to-be-written image 21c. The shot image 20d with the object-to-be-written area extracted includes the object-to-be-written image 21c, the writing content image 22c, and part of a writer image 23d.

(1-3-2-4-2. Processing of Separating Writer Image 23 and Writing Content Image 22)

The processing of separating the writer image 23 and the writing content image 22 will be subsequently described.

The shot image 20d with the object-to-be-written area extracted, which is extracted in the processing of extracting the shot image 20d with the object-to-be-written area extracted, includes part of the writer image 23d. The extraction unit 14 needs to remove part of the writer image 23d from the shot image 20d with the object-to-be-written area extracted in order to extract the writing content image 22 from the shot image 20d with the object-to-be-written area extracted.

Specifically, the processing of separating the writer image 23 and the writing content image 22 is to recognize the shape of part of the writer image 23, or a pattern, for example, from the shot image 20 with the object-to-be-written area extracted, and to exclude the recognized writer image 23.

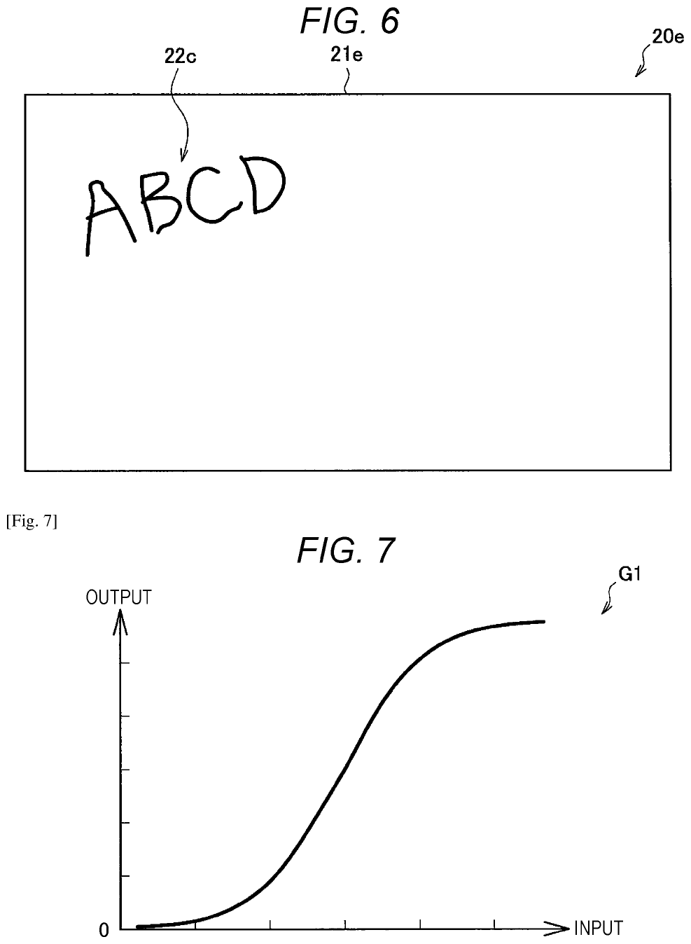

The extraction unit 14 performs the processing of separating the writer image 23 and the writing content image 22 and performs the binarization processing on the separated images so that a shot image 20e subjected to the extraction processing, which includes an object-to-be-written image 21e and the writing content image 22c, is generated as illustrated in FIG. 6.

The processing of extracting the object-to-be-written area and the processing of separating the writer image 23 are performed in this way so that the processing of extracting the writing content image 22 can be correctly performed. Additionally, the example in which the processing of extracting the object-to-be-written area is earlier performed has been described above, but the processing of separating the writer image 23 can be earlier performed.

(1-3-2-5. Correction Unit 15)

The correction unit 15 corrects the form of the writing content image 22 extracted by the extraction unit 14. Specifically, the correction unit 15 corrects the form of the writing content image 22 extracted by the extraction unit 14 such that visibility of the writing content image 22 in the output image 25 is enhanced.

Additionally, correcting the color of the writing content image 22 by the correction unit 15 means correcting the three attributes of color of the writing content image 22. The three attributes of color is hue, saturation, and brightness. The correction unit 15 corrects at least one of hue, saturation, and brightness of the color of the writing content image 22. Additionally, the correction unit 15 may correct one or both of saturation and brightness in order to enhance visibility.

Of course, also in a case where a different scale from the three attributes of color is used, the correction unit 15 can perform the color correction processing. For example, in a case where the correction unit 15 corrects the color of YUV data, it may convert the YUV data to HSV data and may correct one or both of saturation and brightness.

The description will be made below in the present specification assuming that the correction unit 15 corrects one or both of saturation and brightness.

The correction unit 15 determines a color correction processing method on the basis of a combination of the kind of the object-to-be-written image 21 and the background color of the output image 25, and performs the processing of correcting the color of the writing content image 22 in the determined correction processing method. Additionally, in a case where the background color of the output image 25 is assumed as a fixed color, the correction unit 15 may determine a color correction processing method on the basis of only the kind of the object-to-be-written image 21.

How to determine a color correction processing method will be subsequently described. To determine a color correction processing method herein is to determine a filter for correcting saturation or brightness of the writing content image 22, for example. The filter herein means a relationship in which when saturation or brightness is input, saturation or brightness corresponding to the input saturation or brightness is output.

Additionally, a filter for correcting saturation and a filter for correcting brightness may be independently determined. The correction unit 15 corrects saturation or brightness corresponding to each color of the writing content image 22 extracted by the extraction unit 14 by use of the filters.

The correction unit 15 may determine the filters corresponding to a combination of the kind of the object-to-be-written image 21 and the background color of the output image 25 for saturation and brightness, respectively. Specifically, the correction unit 15 may correct brightness of the color of the writing content image 22 on the basis of a difference between brightness of the color of the object 2 to be written and brightness of the background color set by the setting unit 13. More specifically, in a case where the difference between brightness of the color of the object 2 to be written and brightness of the background color set by the setting unit 13 is at a predetermined level or more, the correction unit 15 may correct the brightness of the color of the writing content image 22 to be inverted. That is, the correction unit 15 may correct the brightness of the color of the writing content image 22 such that the relationship of brightness in a plurality of colors of the writing content image 22 is inverted to a relationship of brightness in a plurality of uncorrected colors.

For example, in a case where the object-to-be-written image 21 is a blackboard and the background color of the output image 25 is white, the correction unit 15 may determine a filter for correcting the white writing content image 22 to black. This is because in a case where the white writing content image 22 is combined with the white background, visibility of the writing content image 22 lowers. Further, this is because in a case where the writing content image 22 is combined with the white background, visibility is increased due to the black writing content image 22.

Further, in a case where the writing content image 22 has a plurality of colors, the correction unit 15 may determine a filter for making a difference in saturation or brightness in the plurality of colors of the writing content image 22 higher than a difference in brightness in the plurality of colors of the uncorrected writing content image 22. Specifically, the correction unit 15 may determine the filter such that saturation or brightness higher than that of the other colors is made further higher and saturation or brightness lower than that of the other colors is made further lower for the saturation or brightness of the colors of the writing content image 22.

The filters described above will be described below by way of specific examples with reference to FIG. 7 to FIG. 9. FIG. 7 to FIG. 9 are diagrams for explaining exemplary correction methods by the correction unit 15 according to the present embodiment. The specific examples of the filters described below can be used for correcting both of saturation and brightness.

FIG. 7 illustrates a graph G1 indicating a relationship between input and output. “Input” indicated herein means saturation or brightness of each of the colors of the writing content image 22 extracted by the extraction unit 14. Further, “output” indicated herein means corrected saturation or brightness corresponding to each “input.” In the graph G1 illustrated in FIG. 7, for saturation or brightness at a predetermined level or more, saturation or brightness for “output” is higher than saturation or brightness for “input.” Further, on the other hand, as illustrated in FIG. 7, for saturation or brightness at a predetermined level or less, saturation or brightness for “output” is lower than saturation or brightness for “input.”

Additionally, the curve in the graph G1 is expressed in Equation (1), for example.

$$\begin{matrix}[ Math . 1 ] & \\ {OUTPUT}_{n o r m} = \frac{1}{1 + {e}^{( s - INPUT ) * γ}} & ( 1 )\end{matrix}$$

In Equation (1), s indicates the amount of shift in the horizontal axis, γ indicates a coefficient, and INPUT and OUTPUT indicate input and output, respectively.

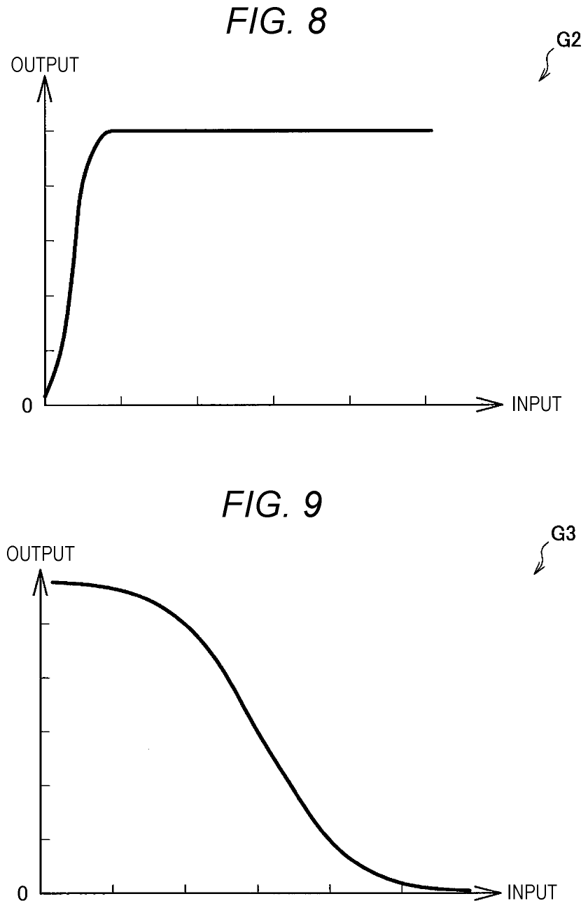

Further, FIG. 8 illustrates a graph G2 indicating a different relationship between input and output from FIG. 7. The graph G2 is different from the graph G1 in that higher saturation or brightness for “output” than for “input” has a wider range. For example, in a case where saturation is corrected by the filter illustrated in the graph G2, saturation of the writing content image 22 extracted by the extraction unit 14 is higher for the saturation of colors other than achromatic colors or its close colors.

Further, there may be present a filter for inverting saturation or brightness. To invert saturation or brightness herein means to correct higher saturation or brightness than the other colors to be lower and to correct lower saturation or brightness than the other colors to be higher for the respective colors.

FIG. 9 illustrates a graph G3 indicating a relationship between input and output. The graph G3 indicates a reverse output result to the graph G1. Specifically, saturation or brightness is lower for “output” than for “input” for saturation or brightness at a predetermined level or more, and saturation or brightness is higher than for “output” than for “input” for saturation or brightness at a predetermined level or less.

Additionally, the curve of the graph G3 is expressed in Equation (2), for example.

$$\begin{matrix}[ Math . 2 ] & \\ {OUTPUT}_{inv} = \frac{1}{1 + {e}^{( INPUT - s ) * γ}} & ( 2 )\end{matrix}$$

In Equation (2), similarly to Equation (1), s indicates the amount of shift in the horizontal axis, γ indicates a coefficient, and INPUT and OUTPUT indicate input and output, respectively.

Additionally, Equation (1) and Equation (2) are merely exemplary, and a filter using other equation may be used.

The filter expressed in the graph G3 is used to correct the writing content image 22 as an image of the writing contents 4 written on a blackboard, for example, and to generate the output image 25 with the white background. The writer 3 typically writes the white writing contents 4 by use of a white chalk on the blackboard in many cases. In a case where the output image 25 is generated from the writing content image 22 corresponding to the white writing contents 4 and the white background, the writing content image 22 and the white background may be difficult to discriminate. Thus, for example, in a case where the kind of the object 2 to be written is a blackboard and the background is white, the correction unit 15 may correct the color of the writing content image 22 by use of the filter expressed in the graph G3 such that brightness of the white writing content image 22 is inverted.

The correction unit 15 may correct saturation or brightness of the color of the writing content image 22 by use of the filters illustrated in FIG. 7 to FIG. 9 described above.

Additionally, the correction unit 15 may use filters other than the filters for increasing the difference in saturation or the difference in brightness illustrated in FIG. 7 to FIG. 9. In other words, the correction unit 15 may use a filter for not increasing the difference in saturation or the difference in brightness. For example, the correction unit 15 may use a filter for outputting input saturation or brightness without changing it, a filter for inverting and outputting input saturation or brightness, or the like.

There will be assumed herein that the output image 25 with the object-to-be-written image 21 as a blackboard, the yellow writing content image 22, and the white background is generated. Brightness of the yellow writing content image 22 written on the blackboard is higher than that of the other colors of the writing content image 22 written on the blackboard, and the yellow writing content image 22 may be used to be further emphasized than the writing content image 22 in the other colors. However, in a case where the output image 25 with the object-to-be-written image 21 as a blackboard and the white background is generated, a filter for inverting brightness is used, and the yellow writing content image 22 with high brightness is lowered in its brightness after being corrected. Thus, it may be difficult to discriminate the corrected yellow writing content image 22 from the corrected white writing content image 22.

In a case where such a situation is assumed, the correction unit 15 may further correct the brightness of the yellow writing content image 22 to be higher after being corrected by use of a filter, for example.

A similar situation to the above situation may occur in the writing content image 22 in a color with hue other than the hue of yellow. Thus, the correction unit 15 may correct a color with predetermined hue depending on a combination of the kind of the object-to-be-written image 21 and the background information. Specifically, the correction unit 15 may correct the brightness of a color with hue for which a difference in brightness from the background color of the output image 25 is a predetermined value or less to be higher than that of the colors of other hue among the colors of the writing content image 22. Specifically, in a case where a difference in brightness corresponding to 10% or less of the difference between the lowest brightness and the highest brightness is caused in the relationship between the brightness of the corrected color of the writing content image 22 and the brightness of the background color, the correction unit 15 may correct the brightness of the writing content image 22 such that the difference in brightness is 20% or more. For example, in a case where the lowest brightness is 0 and the highest brightness is 255, the correction unit 15 may correct the brightness of the writing content image 22 such that the difference in brightness is 51 or more in a case where the difference in brightness is 25 or less.

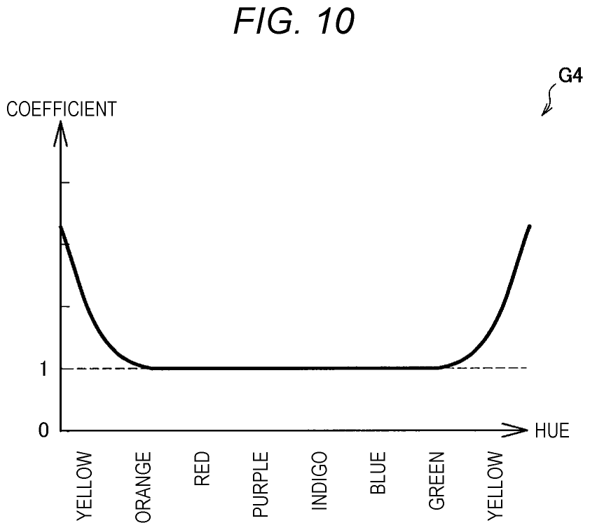

In the correction depending on a difference in brightness, the correction unit 15 may change the output of brightness corresponding to a predetermined hue during correction using a filter depending on a combination of the kind of the object-to-be-written image 21 and the background information. An example will be described below with reference to FIG. 10. FIG. 10 is a diagram for explaining exemplary correction in a quadratic curve in hue at a hue angle of 50 degrees to 70 degrees by the correction unit 15 according to the present embodiment. FIG. 10 illustrates a graph G4. The coefficient values corresponding to the respective hue are indicated in the graph G4. Here, the coefficient is the coefficient γ in Equation (1) and Equation (2). Exemplary correction in hue at a hue angle of 50 degrees to 70 degrees is explained in FIG. 10, but similar correction may be of course made in other range of hue.

Additionally, the correction of brightness depending on a difference in brightness from the background color of the output image 25 has been described above, but similar correction of brightness may be made in consideration of an impact of illumination on the writing contents 4. For example, in a case where the writing contents 4 are illuminated by a illumination device, the writing content image 22 corresponding to the writing contents 4 can seem different from the original color of the writing contents 4 in a color with predetermined hue due to an impact of the illumination. In a case where the correction unit 15 corrects the color of the writing content image 22 with the different color from the original color, discrimination due to a difference in colors intended by the writer 3 may not be caused. Thus, for example, in a case where the situation is expected to occur, the correction unit 15 may correct the brightness of a color with predetermined hue and emphasize the difference between the writing content image 22 with the corrected color of hue and the writing content image 22 with other color.

The writing content image 22 can be appropriately output depending on the kind of the object-to-be-written image 21 by the correction unit 15 in this way. The function enables visibility of the writing content image 22 in the output image 25 to be enhanced or an impact of illumination on the object-to-be-written image 21 to be eliminated.

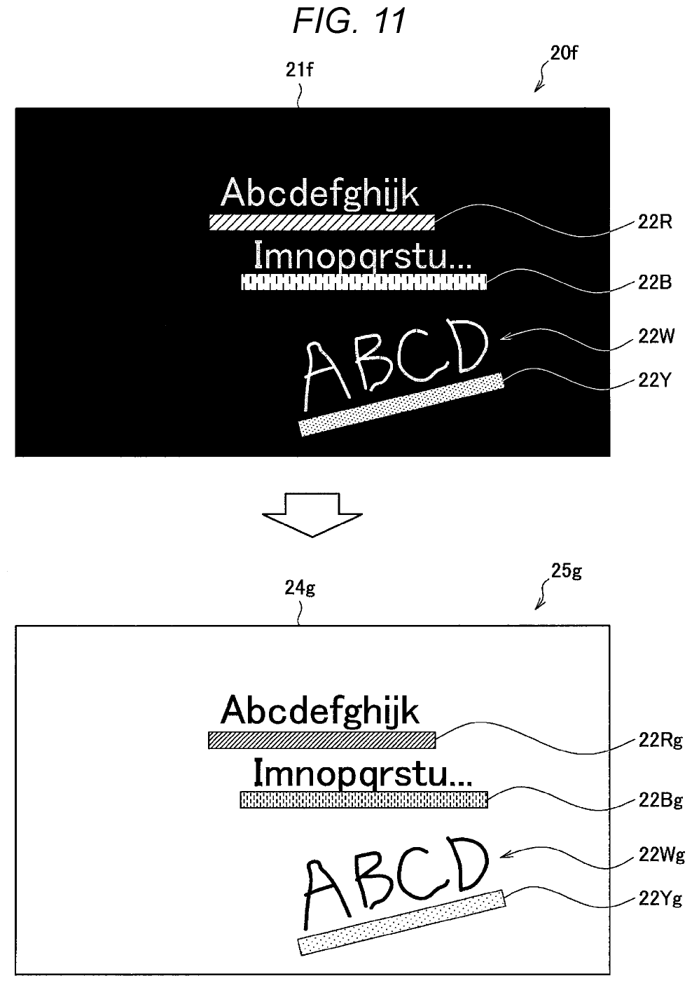

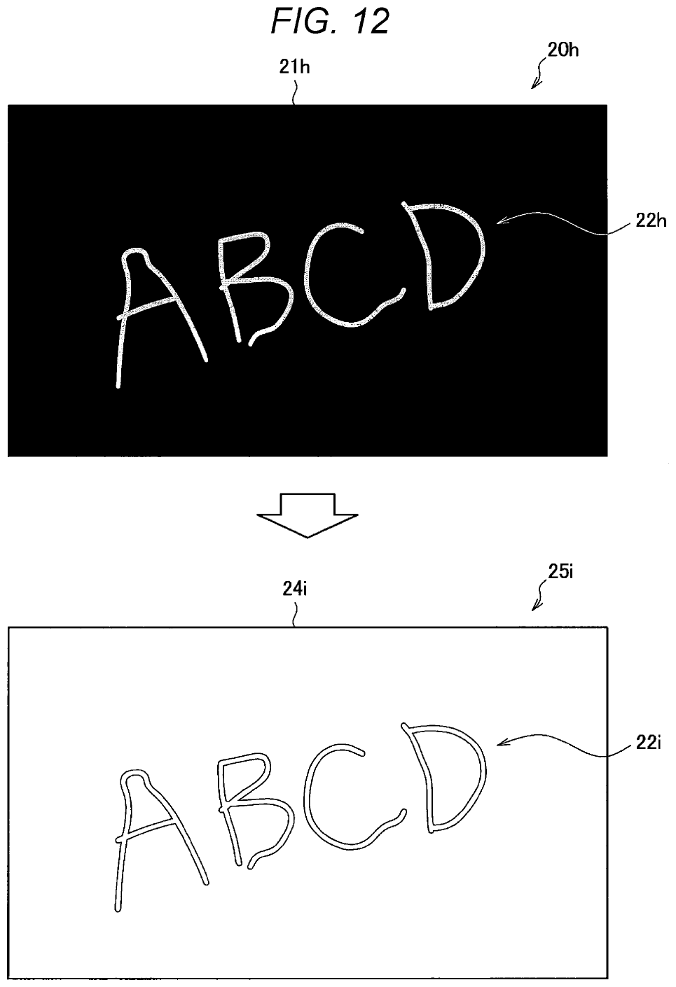

A specific example of performing the correction processing using a filter by the correction unit 15 will be subsequently described with reference to FIG. 11. FIG. 11 is a diagram for explaining a specific example of performing the correction processing using a filter by the correction unit 15.

A shot image 20f subjected to the extraction processing by the extraction unit 14 is illustrated on the upper part of FIG. 11. The shot image 20f includes an object-to-be-written image 21f, and a writing content image 22f such as white characters 22W, a line 22R in color R, a line 22B in color B, and a line 22Y in color Y. Here, the kind of the object-to-be-written image 21 is a blackboard. The correction unit 15 corrects the shot image 20f and generates an output image 25g with the white background. For example, the color R is red, the color B is blue, and the color Y is yellow.

The output image 25g corrected by the correction unit 15 is illustrated in the lower part of FIG. 11. The output image 25g includes a white background image 24g, corrected black characters 22Wg, a corrected line 22Rg in color R, a corrected line 22Bg in color B, and a corrected line 22Yg in color Y. Here, the line 22R in color R, the line 22B in color B, and the like 22Y in color Y are corrected in brightness to the line 22Rg in color R, the line 22Bg in color B, and the line 22Yg in color Y, respectively.

The writing content image 22 can be corrected to enhance visibility depending on the background color of the output image 25 in this way.

Additionally, filters to be determined and objects to be corrected are not limited to the aforementioned examples. For example, in the above, a filter for converting a color of the writing content image 22 is determined on the basis of the kind of the object 2 to be written and the background color of the output image 25, but a filter may be determined for each part of the shot image 20, for example.

Further, the correction unit 15 may correct the contour of the writing content image 22 other than the colors of the writing content image 22. To correct the contour of the writing content image 22 means a processing of emphasizing the contour of the writing content image 22 and erasing the parts other than the contour of the writing content image 22, for example. An exemplary processing of correcting the contour of the writing content image 22 by the correction unit 15 will be described below with reference to FIG. 12. FIG. 12 is a diagram for explaining an exemplary processing of correcting the contour of the writing content image 22 by the correction unit 15 according to the present embodiment.

A shot image 20h subjected to the extraction processing by the extraction unit 14 is illustrated in the upper part of FIG. 12. The shot image 20h includes an object-to-be-written image 21h and a writing content image 22h. Here, the correction unit 15 may correct the contour of the writing content image 22h. An output image 25i including a writing content image 22i corrected by the correction unit 15 is illustrated in the lower part of FIG. 12. The output image 25i includes a background image 24i. The writing content image 22h is corrected in color and contour to the writing content image 22i.

Additionally, the correction unit 15 may correct the contour of part of the writing content image 22 and may not correct the contour of the other part of the writing content image 22. For example, the correction unit 15 may perform the processing of correcting saturation or brightness by use of a filter, then correct the contour of the writing content image 22 in a color with predetermined hue in the writing content image 22 subjected to the correction processing, and may not correct the contour of the writing content image 22 in colors other than the predetermined hue. Additionally, the correction unit 15 may correct the contour of the writing content image 22 detected as characters by the detection unit 12 in the writing content image 22, for example. Objects the contours of which are to be corrected by the correction unit 15 are not limited to the above examples.

The correction unit 15 can correct and emphasize the contour of the writing content image 22 in this way. With the function, the writing content image 22 with the contour corrected can be expressed as different meaning from the other writing content image 22, for example.

(1-3-2-6. Storage Unit 16)

The storage unit 16 stores various items of information indicating the processing of correcting the shot image 20. For example, the storage unit 16 stores labeled data for the kind of the object 2 to be written used by the detection unit 12, a pattern recognition image of the writer 3 used by the extraction unit 14, and the like. Further, the storage unit 16 may store the output image 25 generated by the correction unit 15.

(1-3-2-7. Output Unit 17)

The output unit 17 controls outputting the output image 25 including the writing content image 22 corrected by the correction unit 15. Specifically, the output unit 17 causes the output apparatus 300 described below to output the output image 25 generated by the correction unit 15. The output unit 17 may cause the output apparatus 300 described below to output the output image 25 in real time. Further, the output unit 17 may cause the output apparatus 300 to output an output screen stored in the storage unit 16.

[1-3-3. Output Apparatus 300]

The output apparatus 300 is directed for outputting information under control of the image processing apparatus 100. The output apparatus 300 is realized by a display apparatus such as CRT display apparatus, liquid crystal display apparatus, plasma display apparatus, EL display apparatus, laser projector, LED projector, and lamp.

The output apparatus 300 receives the output image 25 from the output unit 17, and outputs the output image 25. The output apparatus 300 may output the output image 25 as a moving picture in streaming form. In other words, the output apparatus 300 may output the output image 25 in real time.

The output apparatus 300 may output the output image 25 when receiving the output image 25 from the output unit 17. On the other hand, the output apparatus 300 may store the output image 25 received from the output unit 17, and then output it at a later timing. Additionally, the output apparatus 300 may receive the output image 25 stored in the storage unit 16, and output the output image 25 as still image or moving picture.

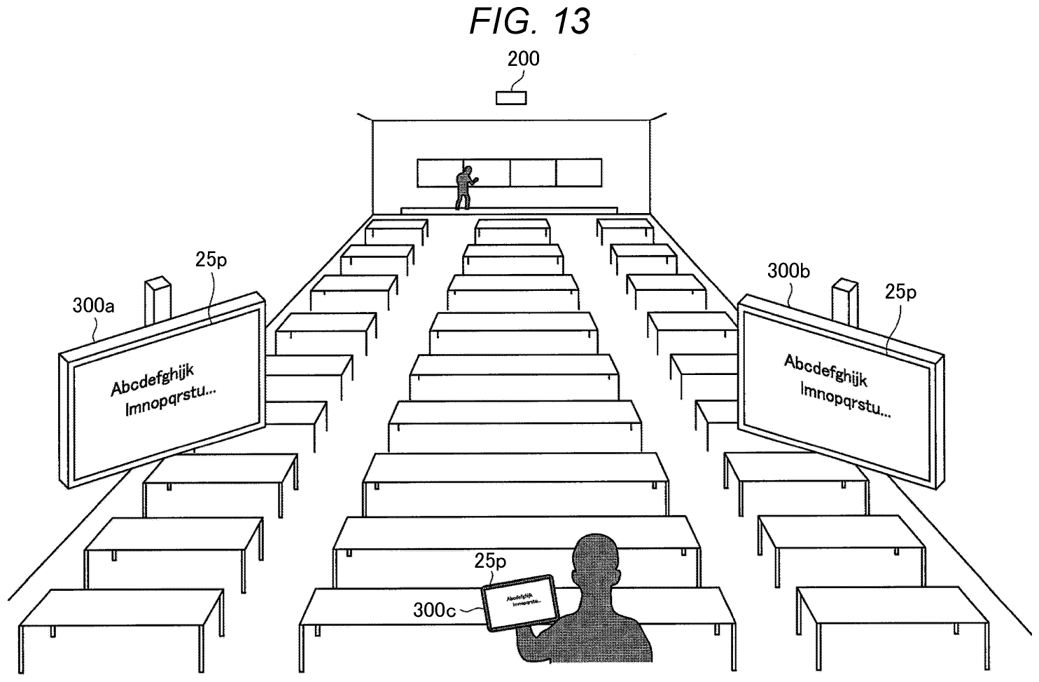

As described above, the output apparatus 300 is realized by various display apparatuses. The output apparatus 300 may be configured of a plurality of display apparatuses. A specific example of the output apparatus 300 will be described herein with reference to FIG. 13. FIG. 13 is a diagram for explaining exemplary output of the output apparatus 300 according to the present embodiment. FIG. 13 illustrates the input apparatus 200 and the output apparatuses 300a, 300b, and 300c.

As illustrated in FIG. 13, the output apparatus 300 may be a display apparatus such as the output apparatuses 300a and 300b. The output apparatus 300 may be a tablet terminal such as the output apparatus 300c. The output apparatuses 300a, 300b, and 300c output an output image 25p, respectively. Additionally, another terminal may connect to the image processing apparatus 100 and access the output image 25p like the output apparatus 300c. Of course, the output of the output image 25 by the output apparatus 300 is not limited to the above examples.

The output image 25 is output by various display apparatuses in this way, thereby confirming the output image 25 depending on an individual situation.

### 2. EXEMPLARY OPERATIONS

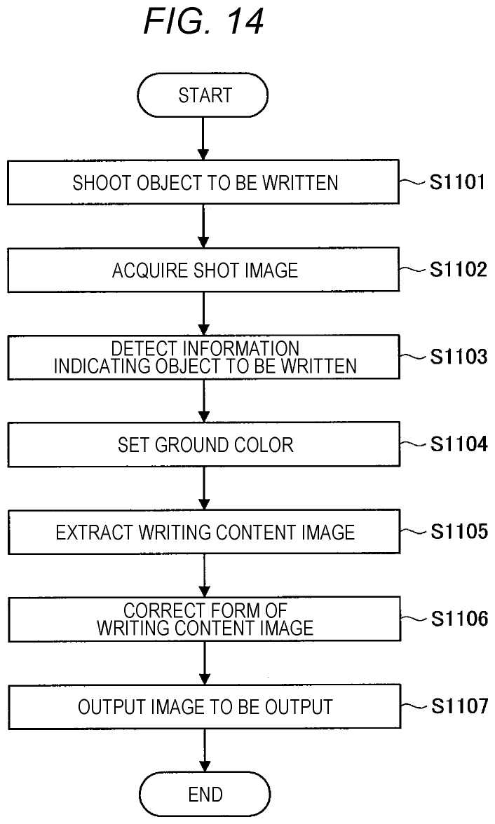

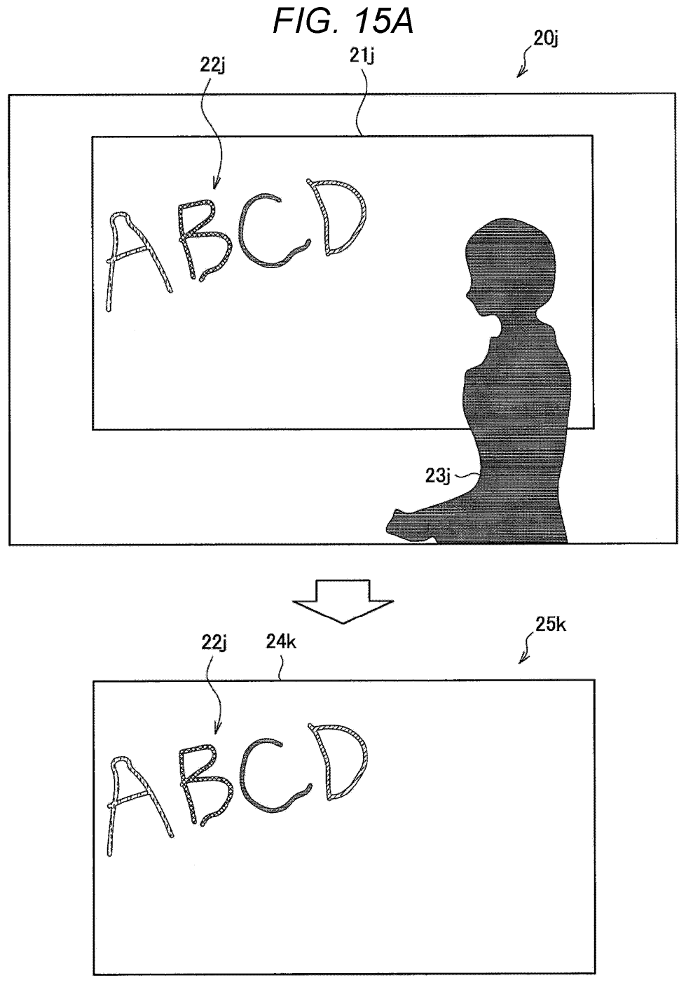

An exemplary flow of operations of the system 1 according to the present embodiment will be subsequently described. FIG. 14 is a diagram for explaining an exemplary flow of operations of the system 1 according to the present embodiment.

With reference to FIG. 14, the input apparatus 200 first shoots the object-to-be-written image 21 (S1101). The acquisition unit 11 then acquires the image shot in step S1101 (S1102). The detection unit 12 then detects the information indicating the object-to-be-written image 21 from the image acquired in step S1102 (S1103). The setting unit 13 then sets the color of the background of the output image 25 (S1104). The extraction unit 14 then extracts the writing content image 22 from the image acquired in step S1102 (S1105).

The extraction unit 14 then extracts the writing content image 22 from the image acquired in step S1102 (S1105). The correction unit 15 then corrects the form of the writing content image 22 extracted in step S1105 on the basis of the information indicating the object-to-be-written image 21 detected in step S1103 and the background color set in step S1104, and generates the output image 25 including the writing content image 22 (S1106). Further, in step S1106, the correction unit 15 may correct the width or contour of the writing content image 22 other than the form of the writing content image 22. Finally, the output apparatus 300 outputs the output image 25 generated in step S1106 (S1107), and the system 1 terminates the operations.

Additionally, in step S1106, the correction unit 15 may generate the output image 25 by correcting the form of the writing content image 22 extracted in step S1105 and then combining the writing content image 22 with the background image. On the other hand, in step S1106, the correction unit 15 may generate the output image 25 by combining the writing content image 22 with the background image and then correcting the form of the writing content image 22.

### 3. APPLICATIONS

As described above, the correction unit 15 corrects the writing content image 22 on the basis of the information indicating the object-to-be-written image 21 and the background color of the output image 25. Additionally, the correction unit 15 may correct the writing content image 22 on the basis of a state of the writer detected by the detection unit 12. The correction processing based on a state of the writer by the correction unit 15 will be described below.

<<3-1. Application 1>>

At first, a state of the writer may be motion information of the writer. The correction unit 15 may further correct the form of the writing content image 22 on the basis of the motion information of the writer. The motion information herein is behavior detection information or the like indicating whether or not the writer is writing on the object-to-be-written image 21, for example. The detection unit 12 may detect that the writer is writing on the object-to-be-written image 21, for example.

Additionally, the detection unit 12 detects a motion of the writer by recognizing a behavior of the writer. Specifically, the detection unit 12 performs behavior recognition in each frame in a still image or moving picture thereby to capture a timing when the writer conducts a motion.

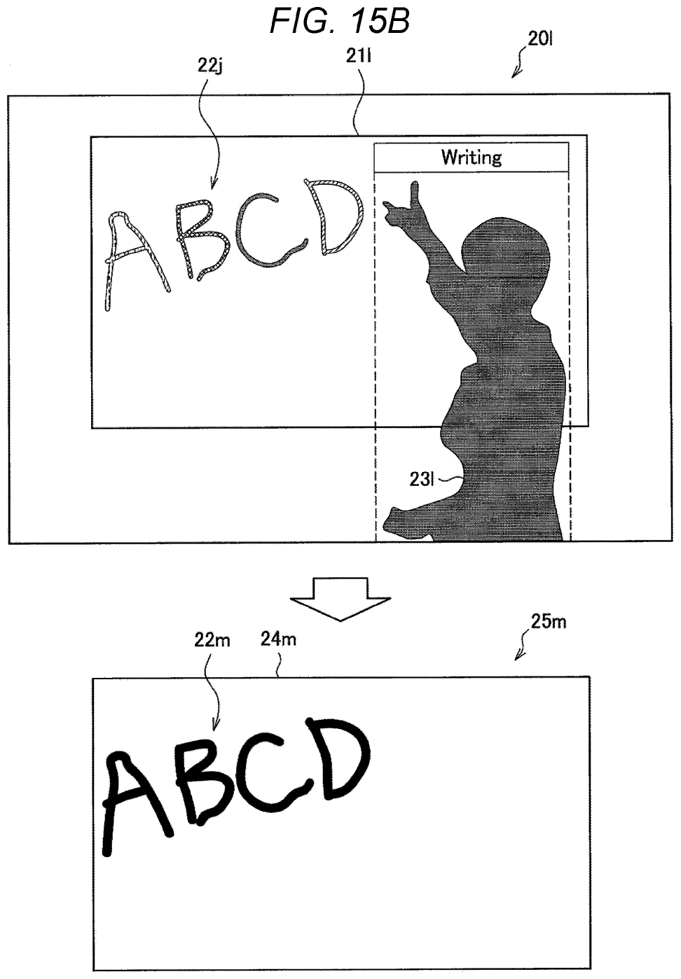

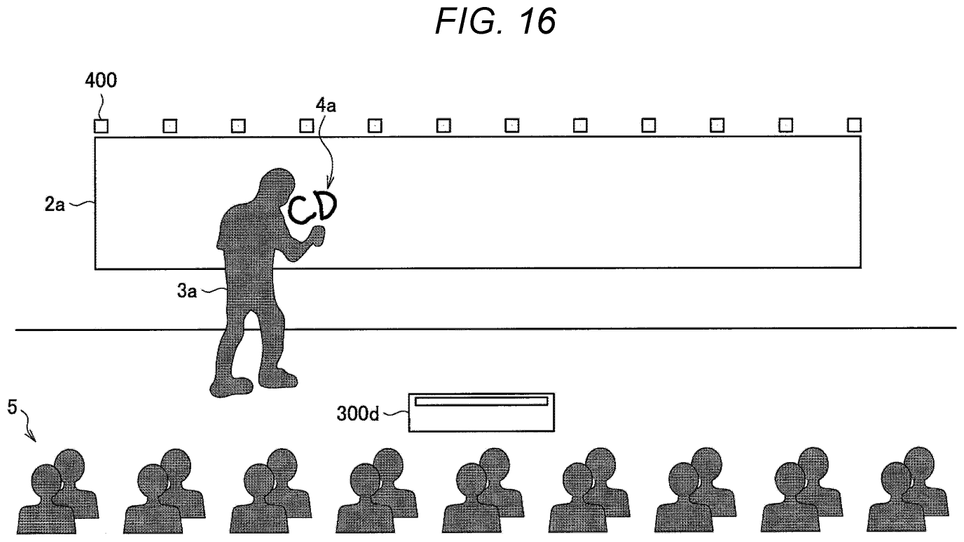

There will be described below the correction processing based on the behavior detection information indicating whether or not the writer is writing on the object-to-be-written image 21 by the correction unit 15 with reference to FIG. 15A and FIG. 15B. FIG. 15A and FIG. 15B are diagrams for explaining the correction processing based on the behavior detection information indicating whether or not the writer is writing on the object-to-be-written image 21 by the correction unit 15 according to the present embodiment by way of example.

In a case where the detection unit 12 detects that the writer is not writing on the object-to-be-written image 21, the correction unit 15 corrects the color of the writing content image 22 on the basis of a combination of the kind of the object 2 to be written and the background color of the output image 25 as described above. On the other hand, in a case where the detection unit 12 detects that the writer is writing on the object 2 to be written, different correction from in a case where the detection unit 12 detects that the writer is not writing on the object 2 to be written is made on the object-to-be-written image 21.

FIG. 15A illustrates a shot image 20j acquired by the acquisition unit 11. The shot image 20j includes a writer image 23j who is not writing on an object-to-be-written image 21j. Further, FIG. 15A illustrates an output image 25k. The output image 25k illustrates a background image 24k and a corrected writing content image 22k therein. Additionally, the writing content image 22k is similar to the writing content image 22j in the example of FIG. 15A.

FIG. 15B illustrates a shot image 201 acquired by the acquisition unit 11. The shot image 201 includes an object-to-be-written image 211, the writing content image 22j, and a writer image 231. Here, the writer image 231 is an image of the writer who is writing.

Here, the detection unit 12 detects that the writer 3 is writing, and the correction unit 15 corrects the color and width of the writing content image 22j. FIG. 15B illustrates an output image 25m. The output image 25m includes a background image 24m and a corrected writing content image 22m. Here, the writing content image 22m changes in its color from the writing content image 22j, and is wider than it.

As illustrated in FIG. 15A and FIG. 15B, for example, when the writer 3 is writing, the correction unit 15 may correct the writing content image 22 such that a person who is viewing the output image 25 can understand that the writer 3 is writing.

Additionally, there has been described above the example in which the correction unit 15 corrects (expands) the width of the writing content image 22 to be larger in a case where the detection unit 12 detects that the writer 3 is writing with reference to FIG. 15A and FIG. 15B. On the other hand, however, in a case where the detection unit 12 detects that the writer 3 is writing, the correction unit 15 may decrease (reduce) the width of the writing content image 22, or may correct the contour of the writing content image 22, or may make correction such that the writing content image 22 is outlined and only the contour thereof remains, for example.

In this way, the writing content image 22 has only to be grasped only by confirming a still image or moving picture which is completely written. The function can eliminate operations of a viewer in a case where the viewer wants to confirm the writing content image 22 later, for example.

<<3-2. Application 2>>

Further, the information indicating the state of the writer 3 may be position relationship information indicating a position relationship between the writer 3 and the object-to-be-written image 21. The correction unit 15 may further correct the writing content image 22 on the basis of the position relationship information. Here, the position relationship between the writer 3 and the object-to-be-written image 21 is a position of the writer 3 relative to the object-to-be-written image 21, for example. The position relationship information may include a time corresponding to a position relationship between the writer 3 and the object-to-be-written image 21, and the writing content image 22 corresponding to the position relationship in the writing content image 22.

Additionally, the system 1 includes a distance measurement apparatus so that the position relationship information is acquired. Here, the distance measurement apparatus includes a distance measurement sensor, for example, and can acquire a distance between the distance measurement sensor and an object.

The processing of correcting the writing content image 22 based on the position relationship between the writer 3 and the object-to-be-written image 21 by the correction unit 15 will be described below with reference to FIG. 16. FIG. 16 is a diagram for explaining the processing of correcting the writing content image 22 based on the position relationship between the writer 3 and the object-to-be-written image 21 by the correction unit 15 according to the present embodiment.

FIG. 16 illustrates how a lecture is. FIG. 16 illustrates an object 2a to be written, a writer 3a, part of writing contents 4a, a student 5, the output apparatus 300d, and a plurality of distance measurement apparatuses 400. The output image 25 output by the output apparatus 300d may be installed to be viewed only by the writer 3. The content output by the output apparatus 300d can be different from the content output by other output apparatuses (e.g., output apparatuses 300a, 300b) in some embodiments. For example, the writer can be notified by the output apparatus 300d that writing is obstructed, for example through the content output by the output apparatus 300d. Here, the writer 3 is standing to hide the writing contents 4. Thus, only part of the writing contents 4a can be viewed by the student 5. Here, the correction unit 15 may correct the color of the writing content image 22 on the basis of the position relationship between the writer 3 and the object-to-be-written image 21.

The example of FIG. 16 will be described. A plurality of distance measurement apparatuses 400 acquire a distance between each of the distance measurement apparatus 400 and the writer 3. The detection unit 12 detects the position of the writer relative to the object-to-be-written image 21.

Here, in a case where the position of the writer detected by the detection unit 12 is hiding the writing content image 22 for a predetermined time, the correction unit 15 may correct the writing content image 22 to notify the writer 3 of the fact that he/she is hiding the writing content image 22.

Specifically, in a case where the fact that a change in the position relationship between the writer 3 and the writing content image 22 is at a predetermined amount or less for a predetermined time is indicated as position relationship information, the correction unit 15 may correct the writing content image 22 corresponding to the position relationship. For example, in a case where a change in position of the writer 3 is at a predetermined amount or less for a predetermined time, the correction unit 15 may correct the color of the writing content image 22, or the color of the hidden writing content image 22 or the vicinity of the hidden writing content image 22 to a predetermined color to notify the writer 3 of the fact that the writing content image 22 present at the position of the object 2 to be written close to the position of the writer 3 is hidden, for example.

In the case of the example of FIG. 16, in a case where a change in position of the writer 3 is at a predetermined amount or less for a predetermined time, the correction unit 15 corrects the color of the writing contents 4a or the writing content image 22 hidden by the writer 3 to a predetermined color. In the case of the example of FIG. 16, the corrected writing content image 22 is output to the output apparatus 300 (e.g., output apparatus 300d) and notified to the writer 3.

In this way, the fact that a student cannot see the writing content image 22 due to the hidden writing content image 22 can be notified to the writer. The function enables the writer to behave for more comfortable lecture to students.

Additionally, the information indicating the position relationship between the writer 3 and the object 2 to be written may be acquired by use of a shooting apparatus other than the distance measurement apparatuses 400. The shooting apparatus may use the input apparatus 200, for example. Further, in a case where the object 2 to be written is an electronic blackboard, the object 2 to be written may directly output the output image 25.

### 4. EXEMPLARY HARDWARE CONFIGURATION

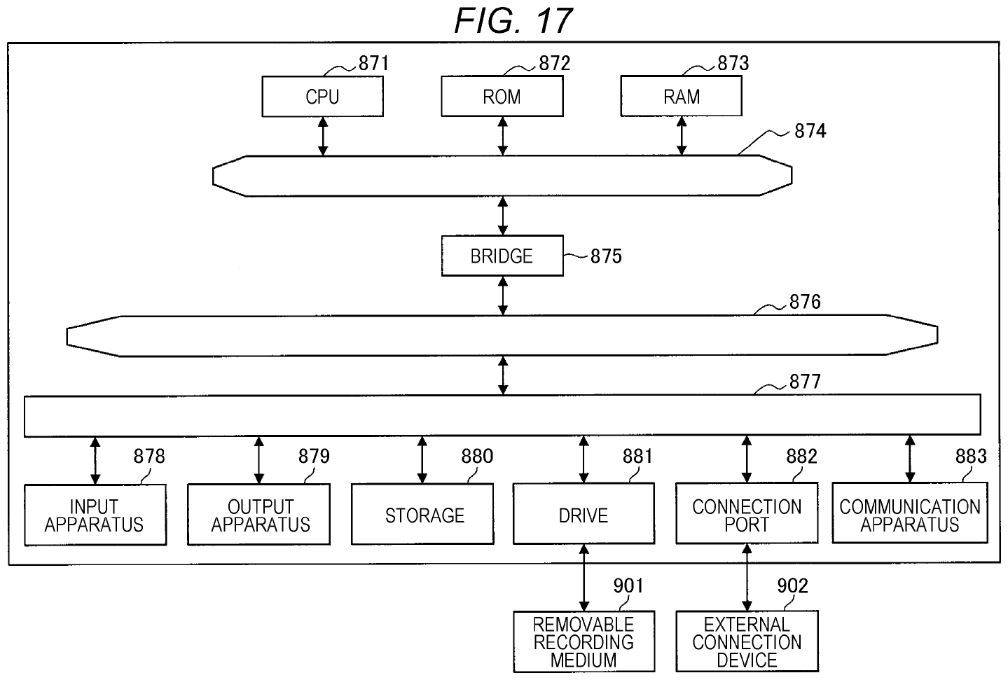

An exemplary hardware configuration of the image processing apparatus 100, the input apparatus 200, and the output apparatus 300 according to an embodiment of the present disclosure will be described below. FIG. 17 is a block diagram illustrating an exemplary hardware configuration of the image processing apparatus 100, the input apparatus 200, and the output apparatus 300 according to an embodiment of the present disclosure. With reference to FIG. 17, the image processing apparatus 100, the input apparatus 200, and the output apparatus 300 include a processor 871, a ROM 872, a RAM 873, a host bus 874, a bridge 875, an external bus 876, an interface 877, an input apparatus 878, an output apparatus 879, a storage 880, a drive 881, a connection port 882, and a communication apparatus 883, for example. Additionally, the hardware configuration illustrated herein is exemplary, and some components may be omitted. Further, components other than the components illustrated herein may be further provided.

(Processor 871)

The processor 871 is an example of processing circuitry that functions as a computation processing apparatus or control apparatus, for example, and controls all or part of operations of each component on the basis of various programs recorded in the ROM 872, the RAM 873, the storage 880, or a removable recording medium 901.

(ROM 872, RAM 873)

The ROM 872 is a device for storing programs read by the processor 871, or data used for computations, and the like. The RAM 873 temporarily or permanently stores programs read by the processor 871, various parameters changing as appropriate when the programs are executed, or the like, for example.

Additionally, the functions of the acquisition unit 11, the detection unit 12, the setting unit 13, the extraction unit 14, the correction unit 15, the output unit 17, the input apparatus 200, the output apparatus 300, and the like are realized in cooperation of the processor 871, the ROM 872, and the RAM 873 with software.

(Host Bus 874, Bridge 875, External Bus 876, Interface 877)

The processor 871, the ROM 872, and the RAM 873 are mutually connected via the host bus 874 capable of transmitting data at high speed, for example. On the other hand, the host bus 874 is connected to the external bus 876 with a relatively low data transmission speed via the bridge 875, for example. Further, the external bus 876 is connected to various components via the interface 877.

(Input Apparatus 878)

The input apparatus 878 uses a mouse, a keyboard, a touch panel, a button, a switch, a lever, and the like, for example. Further, the input apparatus 878 may use a remote controller capable of transmitting a control signal by use of infrared ray or other radio waves. Further, the input apparatus 878 includes a speech input apparatus such as microphone.

(Output Apparatus 879)

The output apparatus 879 is an apparatus capable of visually or aurally notifying a user of acquired information, for example, a display apparatus such as cathode ray tube (CRT), LCD, or organic EL, an audio output apparatus such as speaker or headphones, a printer, a cell phone, or a facsimile. Further, the output apparatus 879 according to the present disclosure includes various oscillation devices capable of outputting tactile stimulation. The functions of the output apparatus 300 are realized by the output apparatus 879.

(Storage 880)

The storage 880 is an apparatus for storing various items of data therein. The storage 880 may use a magnetic storage device such as hard disc drive (HDD), a semiconductor storage device, an optical storage device, a magnetooptical storage device, or the like, for example. The functions of the storage unit 16 and the like are realized by the storage 880.

(Drive 881)

The drive 881 is an apparatus for reading information recorded in a removable recording medium 901 such as magnetic disc, optical disc, magnetooptical disc, semiconductor memory, or the like, and writing information in the removable recording medium 901.

(Removable Recording Medium 901)

The removable recording medium 901 may be a DVD medium, a Blu-ray (registered trademark) medium, a HD DVD medium, various semiconductor storage medium, or the like, for example. Of course, the removable recording medium 901 may be an IC card mounting a non-contact IC chip thereon, an electronic device, or the like, for example.

(Connection Port 882)

The connection port 882 is a port for connecting an external connection device 902 such as universal serial bus (USB), IEEE 1394 port, small computer system interface (SCSI), RS-232C port, audio terminal, or the like.

(External Connection Device 902)

The external connection device 902 is a printer, a portable music player, a digital camera, a digital video camera, an IC recorder, or the like, for example.

(Communication Apparatus 883)

The communication apparatus 883 is a communication device for connecting to a network, and is a communication card for wired or wireless LAN, Bluetooth (registered trademark), or wireless USB (WUSB), an optical communication router, an asymmetric digital subscriber line (ADSL) router, a modem for various communications, or the like, for example. The communication apparatus 883 is used so that wireless communication between the image processing apparatus 100 and the output apparatus 300 as a terminal apparatus can be realized.

### 5. CONCLUSION

An embodiment of the present disclosure has been described above with reference to FIG. 1 to FIG. 17. As described above, the image processing apparatus 100 according to the present embodiment extracts the writing content image 22 written on the object-to-be-written image 21, and corrects the form of the writing content image 22 on the basis of the information indicating the object-to-be-written image 21 and the background color of the output image 25. Thereby, visibility of the writing content image 22 in the output image 25 can be enhanced. Further, an additional meaning can be given to the writing content image 22.

The embodiment of the present disclosure has been described above in detail with reference to the accompanying drawings, but the technical scope of the present disclosure is not limited to the example. It is clear that those skilled in the art in the technical field of the present disclosure can easily understand various exemplary changes or exemplary modifications in the scope of the technical spirit described in the claims below and these belong to the technical scope of the present disclosure.

Further, the effects described in the present specification are explanatory or exemplary, and are not restrictive. That is, the technology according to the present disclosure can obtain the above effects, or other effects clear to those skilled in the art from the description of the present specification instead of the above effects.

Further, the processing described in the flowcharts and the sequence diagrams in the present specification do not necessarily need to be performed in the illustrated orders. Some processing steps may be performed in parallel. Further, an additional processing step may be employed, or some processing steps may be omitted.

Additionally, the following configurations belong to the technical scope of the present disclosure.

(1)
An image processing apparatus includes processing circuitry configured to modify one or more characteristics of a writing content image of writing contents written on a writing surface, the modification of the one or more characteristics of the writing content image being based on information related to the writing surface.

(2)
The image processing apparatus according to (1), in which the processing circuitry is further configured to modify the one or more characteristics of the writing content image based on a background color of an output image.

(3)
The image processing apparatus according to (1) or (2), in which the one or more characteristics of the writing content image includes a color.

(4)
The image processing apparatus according to (3), in which the processing circuitry is configured to modify the color to improve visibility of the writing contents.

(5)
The image processing apparatus according to any of (1) to (4), in which the one or more characteristics of the writing content image includes at least one of hue, brightness, or saturation of the writing content image, and the processing circuitry is configured to modify the at least one of hue, brightness, or saturation of the writing content image.

(6)
The image processing apparatus according to any of (1) to (5), in which
the one or more characteristics of the writing content image includes brightness of a first color of the writing content image, and
the processing circuitry is configured to modify the brightness of the first color of the writing content image in order to increase a difference in brightness between the first color and a second color of the writing content image.

(7)
The image processing apparatus according to (6), in which
the first color of the writing content image has a hue angle that is in a range of 50 to 70 degrees, and
the processing circuitry is configured to increase the brightness of the first color.

(8)
The image processing apparatus according to any of (1) to (7), in which
the one or more characteristics of the writing content image includes brightness of a plurality of colors of the writing content image, and
an order of the brightness of the plurality of colors of the writing content image prior to the modification of the one or more characteristics is reversed after the one or more characteristics is modified.

(9)
The image processing apparatus according to any of (1) to (8), in which
the one or more characteristics of the writing content image includes brightness of a color of the writing content image,
the characteristic of the writing surface is brightness of a color of the writing surface, and
the processing circuitry is configured to modify the brightness of a color of the writing content image based on a difference between the brightness of the color of the writing surface and brightness of a background color of an output image.

(10)
The image processing apparatus according to any of (1) to (9), in which
the one or more characteristics of the writing content image includes brightness of a color of the writing content image, and
the processing circuitry is configured to modify the brightness of the color of the writing content image based on a hue of the color of the writing content image.

(11)
The image processing apparatus according to any of (1) to (10), in which
the one or more characteristics of the writing content image includes brightness of a color of the writing content image, and
the processing circuitry is configured to modify the brightness of the color of the writing content image when a difference between the brightness of the color of the writing content image and a brightness of a background color of an output image is at a first predetermined value or less such that the difference in the brightness of the background color and the brightness of the color of the writing content image is at a second predetermined value or more.

(12)
The image processing apparatus according to any of (1) to (11), in which
the one or more characteristics of the writing content image includes saturation of one of a plurality of colors of the writing content image, and
the processing circuitry is configured to modify the saturation of the one of the plurality of colors of the writing content image to increase a difference in saturation between the plurality of colors of the writing content image.

(13)
The image processing apparatus according to any of (1) to (12), in which the processing circuitry is configured to modify a characteristic of the writing content image based on information regarding a detected state of a writer.

(14)
The image processing apparatus according to (13), in which
the information regarding the detected state of the writer indicates whether or not the writer is writing on the writing surface, and
the processing circuitry is configured to modify the characteristic of the writing content image in a case that the information regarding the detected state of the writer indicates that the writer is writing on the writing surface.

(15)
The image processing apparatus according to (13) or (14), in which
the information regarding the detected state of the writer indicates a position relationship between the writer and the writing surface, and
the processing circuitry is configured to modify the characteristic of the writing content image based on the indicated position relationship.

(16)
The image processing apparatus according to (15), in which the processing circuitry is configured to modify the characteristic of the writing content image in a case that writing in the writing content image is obstructed by the writer.

(17)
The image processing apparatus according to any of (1) to (16), in which the processing circuitry is configured to modify a width of the writing content image.

(18)
The image processing apparatus according to any of (1) to (17), in which the processing circuitry is configured to modify a contour in the writing content image.

(19)
The image processing apparatus according to any of (1) to (18), in which the processing circuitry is configured to
detect the writing surface, and
modify the one or more characteristics of the writing content image based on information indicating a type of the detected writing surface.

(20)
The image processing apparatus according to any of (1) to (19), in which the processing circuitry is configured to
extract the writing content image from an image of the writing surface, and modify the one or more characteristics of the extracted writing content image.

(21)
The image processing apparatus according to any of (1) to (20), in which the processing circuitry is configured to
control outputting of an output image including the writing content image after the one or more characteristics of the writing content image is modified.

(22)
The image processing apparatus according to any of (1) to (21), in which the processing circuitry is configured to
output a first modified version of the writing content image to a first display, the first modified version of the writing content image including the modification of the one or more characteristics of the writing content image, and
output a second modified version of the writing content image to a second display.

(23)
The image processing apparatus according to any of (1) to (22), in which the information related to the writing surface indicates one or a combination of a reflectivity of the writing surface and residue on the writing surface.

(24)
An image processing method including modifying, by processing circuitry of an image processing apparatus, one or more characteristics of a writing content image of writing contents written on a writing surface, the modification of the one or more characteristics of the writing content image being based on information related to the writing surface.

(25)
An image processing method for performing the functions of the image processing apparatus according to any of (1) to (23).

(26)
A non-transitory computer-readable storage medium storing instructions which when executed by a computer cause the computer to perform a method including modifying one or more characteristics of a writing content image of writing contents written on a writing surface, the modification of the one or more characteristics of the writing content image being based on information related to the writing surface.

(27)
A non-transitory computer-readable storage medium storing instructions which when executed by a computer cause the computer to perform a method according to (24) or (25).

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

100 Image processing apparatus
11 Acquisition unit
12 Detection unit
13 Setting unit
14 Extraction unit
15 Correction unit
16 Storage unit
17 Output unit
200 Input apparatus
300 Output apparatus
400 Distance measurement apparatus

1. An image processing apparatus comprising:
processing circuitry configured to
modify one or more characteristics of a writing content image of writing contents written on a writing surface, the modification of the one or more characteristics of the writing content image being based on information related to the writing surface.

2. The image processing apparatus according to claim 1,
wherein the processing circuitry is further configured to modify the one or more characteristics of the writing content image based on a background color of an output image.

3. The image processing apparatus according to claim 1, wherein the one or more characteristics of the writing content image includes a color.

4. The image processing apparatus according to claim 3, wherein the processing circuitry is configured to modify the color to improve visibility of the writing contents.

5. The image processing apparatus according to claim 1, wherein
the one or more characteristics of the writing content image includes at least one of hue, brightness, or saturation of the writing content image, and
the processing circuitry is configured to modify the at least one of hue, brightness, or saturation of the writing content image.

6. The image processing apparatus according to claim 1,
wherein
the one or more characteristics of the writing content image includes brightness of a first color of the writing content image, and
the processing circuitry is configured to modify the brightness of the first color of the writing content image in order to increase a difference in brightness between a first color and a second color of the writing content image.

7. The image processing apparatus according to claim 6, wherein
the first color of the writing content image has a hue angle that is in a range of 50 to 70 degrees, and
the processing circuitry is configured to increase the brightness of the first color.

8. The image processing apparatus according to claim 1,
wherein
the one or more characteristics of the writing content image includes brightness of a plurality of colors of the writing content image, and
an order of the brightness of the plurality of colors of the writing content image prior to the modification of the one or more characteristics is reversed after the one or more characteristics is modified.

9. The image processing apparatus according to claim 1, wherein
the one or more characteristics of the writing content image includes brightness of a color of the writing content image,
the characteristic of the writing surface is brightness of a color of the writing surface, and
the processing circuitry is configured to modify the brightness of a color of the writing content image based on a difference between the brightness of the color of the writing surface and brightness of a background color of an output image.

10. The image processing apparatus according to claim 1, wherein
the one or more characteristics of the writing content image includes brightness of a color of the writing content image, and
the processing circuitry is configured to modify the brightness of the color of the writing content image based on a hue of the color of the writing content image.

11. The image processing apparatus according to claim 1, wherein
the one or more characteristics of the writing content image includes brightness of a color of the writing content image, and
the processing circuitry is configured to modify the brightness of the color of the writing content image when a difference between the brightness of the color of the writing content image and a brightness of a background color of an output image is at a first predetermined value or less such that the difference in the brightness of the background color and the brightness of the color of the writing content image is at a second predetermined value or more.

12. The image processing apparatus according to claim 1, wherein
the one or more characteristics of the writing content image includes saturation of one of a plurality of colors of the writing content image, and
the processing circuitry is configured to modify the saturation of the one of the plurality of colors of the writing content image to increase a difference in saturation between the plurality of colors of the writing content image.

13. The image processing apparatus according to claim 1, wherein the processing circuitry is configured to modify a characteristic of the writing content image based on information regarding a detected state of a writer.

14. The image processing apparatus according to claim 13, wherein
the information regarding the detected state of the writer indicates whether or not the writer is writing on the writing surface, and
the processing circuitry is configured to modify the characteristic of the writing content image in a case that the information regarding the detected state of the writer indicates that the writer is writing on the writing surface.

15. The image processing apparatus according to claim 13, wherein
the information regarding the detected state of the writer indicates a position relationship between the writer and the writing surface, and
the processing circuitry is configured to modify the characteristic of the writing content image based on the indicated position relationship.

16. The image processing apparatus according to claim 15, wherein the processing circuitry is configured to modify the characteristic of the writing content image in a case that writing in the writing content image is obstructed by the writer.

17. The image processing apparatus according to claim 1, wherein the processing circuitry is configured to modify a width of the writing content image.

18. The image processing apparatus according to claim 1, wherein the processing circuitry is configured to modify a contour in the writing content image.

19. The image processing apparatus according to claim 1, wherein the processing circuitry is configured to
detect the writing surface, and
modify the one or more characteristics of the writing content image based on information indicating a type of the detected writing surface.

20. The image processing apparatus according to claim 1, wherein the processing circuitry is configured to
extract the writing content image from an image of the writing surface, and
modify the one or more characteristics of the extracted writing content image.

21. The image processing apparatus according to claim 1, wherein the processing circuitry is configured to
control outputting of an output image including the writing content image after the one or more characteristics of the writing content image is modified.

22. The image processing apparatus according to claim 1, wherein the processing circuitry is configured to
output a first modified version of the writing content image to a first display, the first modified version of the writing content image including the modification of the one or more characteristics of the writing content image, and
output a second modified version of the writing content image to a second display.

23. The image processing apparatus according to claim 1, wherein the information related to the writing surface indicates one or a combination of a reflectivity of the writing surface and residue on the writing surface.

24. An image processing method comprising:
modifying, by processing circuitry of an image processing apparatus, one or more characteristics of a writing content image of writing contents written on a writing surface, the modification of the one or more characteristics of the writing content image being based on information related to the writing surface.

25. A non-transitory computer-readable storage medium storing instructions which when executed by a computer cause the computer to perform a method comprising:
modifying one or more characteristics of a writing content image of writing contents written on a writing surface, the modification of the one or more characteristics of the writing content image being based on information related to the writing surface.
